(19) United States
(12) Patent Application Publication
(10) Pub. No.: US 2023/0192435 A1
(43) Pub. Date: Jun. 22, 2023

(54) Apparatus and method for converting a sheet into a continuous strip

(71) Applicant: VMI HOLLAND B.V., EPE (NL)

(72) Inventors: Gerben MULDER, EPE (NL); Cornelis VELDHOEN, EPE (NL)

(21) Appl. No.: 18/110,227

(22) Filed: Feb. 15, 2023

Related U.S. Application Data
(62) Division of application No. 16/761,479, filed on May 4, 2020, now abandoned.

(30) Foreign Application Priority Data
Nov. 3, 2017 (NL) 2019851

(51) Int. Cl. B65H 35/08

(52) U.S. Cl. CPC B65H 35/08; B65H 2301/51512; B65H 2301/5152; B65H 2701/177

(57) ABSTRACT

The invention relates to an apparatus and a method for converting a sheet into a continuous strip, wherein the apparatus comprises a cutting device with one or more cutting members, one or more drives and a feeding device, wherein the apparatus is provided with one or more sensors for detecting the first longitudinal edge and the second longitudinal edge of the sheet and a control unit that is connected to the one or more drives, the feeding device and the one or more sensors for controlling the movement of the one more cutting members relative to the sheet based on the detection to create a sequence of cuts to form interconnected sheet sections, wherein the control unit is arranged for variably controlling the strip width.

### CROSS REFERENCE TO RELATED APPLICATIONS

This application is a divisional application of U.S. patent application Ser. No. 16/761,479, filed May 4, 2020, which in turn is a 371 filing of PCT International Patent Application Serial No. PCT/NL2018/050702, filed Oct. 23, 2018, the contents of which are incorporated herein by reference.

### BACKGROUND OF THE INVENTION

The invention relates to an apparatus and a method for converting a sheet into a continuous strip.

WO 2017/171545 A1 discloses an apparatus with a cutting device for converting a sheet into a continuous strip for use as infeed material for an extruder. The cutting device is a rotary cutter comprising a plurality of the knives which are distributed evenly around the circumference of a rotatable cylindrical body for cutting a sequence of cuts into the sheet in a cutting direction transversely across the sheet. The knives extend alternately from one end of the cylindrical body towards and terminate short of the other end of the cylindrical body. Each knife thus effectively starts at a respective end of the cylindrical body and creates a corresponding cut in the sheet towards yet short of the opposite end of the cylindrical body. The resulting cuts extend alternately from one longitudinal edge and terminating short of the other longitudinal edge of the sheet. The sequence of cuts form a plurality of interconnected sheet sections which are pulled apart in a feeding direction to form zig-zag sections of the continuous strip.

### SUMMARY OF THE INVENTION

A disadvantage of the known apparatus is that the sheet, which essentially is a slab of raw rubber material, may vary in width, thickness and/or shape along the length of the sheet. Such inconsistencies in the sheet may cause unpredictable results when converting said sheet into a continuous strip and/or when feeding said continuous strip into an extruder. When the sequence of cuts does not fit properly within the dimensions of the sheet, one of the cuts may fail to terminate short of the respective longitudinal edge, thereby interrupting the continuous strip, or one of the cuts may terminate way too short with respect to the respective longitudinal edge, thereby causing a relatively wide transition from one zig-zag section to the next zig-zag section in the continuous strip. Inconsistencies in the width of the resulting continuous strip may cause clogging of the extruder.

It is an object of the present invention to provide an apparatus and a method for converting a sheet into a continuous strip, wherein said conversion can be improved.

According to a first aspect, the invention provides an apparatus for converting a sheet into a continuous strip, wherein the sheet has a sheet body extending in a longitudinal direction and having a first longitudinal edge and a second longitudinal edge extending on opposite sides of the sheet body, wherein the apparatus comprises a cutting device with one or more cutting members for cutting the sheet along one or more cutting lines and a feeding device for feeding the sheet in a feeding direction and in a feeding plane across the one or more cutting lines, wherein the apparatus comprises one or more drives for providing a relative movement between the one or more cutting members and the sheet, wherein the apparatus is provided with one or more sensors for detecting the first longitudinal edge and the second longitudinal edge and a control unit that is operationally connected to the one or more drives, the feeding device and the one or more sensors for controlling the movement of the one or more cutting members relative to the sheet based on the detection of the first longitudinal edge and the second longitudinal edge by the one or more sensors to create a sequence of cuts in which the cuts are spaced apart in the feeding direction over a strip width and alternately extend in a first cutting direction transverse to the feeding direction and parallel to the feeding plane from one of the longitudinal edges towards and terminate at a transition width short of the other of the longitudinal edges to form a plurality of interconnected sheet sections, wherein the one or more sensors or one or more additional sensors are arranged for detecting the cross section or the height profile of the sheet, and wherein the control unit is arranged for variably controlling the strip width in response to the detected cross section or the detected height profile.

When the height profile or cross section has inconsistencies, e.g. if the sheet is relatively thin, the strip width can be increased to prevent unintentional interruption of the sheet at the transition from one sheet section to the next. In this manner, the consistency of the strip can be improved. By using one or more sensors, the termination of the cuts short of the longitudinal edges can be accurately controlled. The detection-based movement can prevent that one of the cuts is terminated to early or too late with respect to the actual width or shape of the sheet. Hence, after pulling apart the interconnected sheet sections to form the zig-zag sections of the continuous strip, said continuous strip can be more consistent. Thus, unintentional interruption of said strip or clogging of the extruder can be prevented. The strip width defines the width of the continuous strip after the interconnected sheet sections have been pulled apart. By controlling the strip width, i.e. by controlling the spacing between the one or more cutting members in the feeding direction or by controlling the feeding device to advance the sheet after each cut, the width of the continuous strip can be adjusted and/or variably adjusted depending on the requirements for the continuous strip and/or in response to certain parameters of the downstream stations, i.e. the extruder. In one embodiment the control unit is arranged for keeping the transition width constant. Hence, the transition width can be kept the same, regardless of the actual width and/or shape of the sheet.

In an alternative embodiment the control unit is arranged for variably controlling the transition width. In this way, the transition width can be adjusted and/or variably adjusted depending on the requirements for the continuous strip and/or in response to certain parameters of the downstream stations.

In an alternative embodiment thereof the transition width is controlled to be equal or substantially equal to the strip width. Hence, the consistency of the width of the continuous strip, in particular at the transition from one zig-zag section to the next, can be improved.

According to a second aspect, the present invention relates to an apparatus for converting a sheet into a continuous strip, wherein the sheet has a sheet body extending in a longitudinal direction and having a first longitudinal edge and a second longitudinal edge extending on opposite sides of the sheet body, wherein the apparatus comprises a cutting device with one or more cutting members for cutting the sheet along one or more cutting lines and a feeding device for feeding the sheet in a feeding direction and in a feeding plane across the one or more cutting lines, wherein the apparatus comprises one or more drives for providing a relative movement between the one or more cutting members and the sheet, wherein the apparatus is provided with one or more sensors for detecting the first longitudinal edge and the second longitudinal edge and a control unit that is operationally connected to the one or more drives, the feeding device and the one or more sensors for controlling the movement of the one or more cutting members relative to the sheet based on the detection of the first longitudinal edge and the second longitudinal edge by the one or more sensors to create a sequence of cuts in which the cuts are spaced apart in the feeding direction over a strip width and alternately extend in a first cutting direction transverse to the feeding direction and parallel to the feeding plane from one of the longitudinal edges towards and terminate at a transition width short of the other of the longitudinal edges to form a plurality of interconnected sheet sections, wherein the one or more sensors or one or more additional sensors are arranged for detecting the cross section or the height profile of the sheet, wherein the control unit is arranged for variably controlling the transition width in response to the detected cross section or the detected height profile. Preferably, the control unit is arranged for variably controlling the strip width.

When the height profile or cross section has inconsistencies, e.g. if the sheet is relatively thin, the transition width can be increased to prevent unintentional interruption of the sheet at the transition from one sheet section to the next.

In an embodiment of either the first or the second aspect the apparatus comprises a line camera or laser triangulation for detecting the cross section or the height profile of the sheet.

In a further embodiment, the control unit is arranged for calculating the volume or the mass of the sheet that has passed the one or more sensors or the one or more additional sensors from the cross section or the height profile. Optionally, the control unit is arranged for sending a notification signal to an operator when a predetermined value for the volume or the mass has been reached. In this manner, the consistency of the strip, and in particular its volumetric rate in the feeding direction, can be improved. Thus, it can be ensured that a consistent volume of material is fed into the extruder over time.

In an embodiment thereof, the sheet is supplied to the apparatus from a stack, wherein the predetermined value is related to the volume or mass of the entire sheet in the stack, and wherein the control unit is arranged to provide the notification signal to alert the operator that the stack is nearly depleted.

In a further embodiment, for each cut of the sequence of cuts, the control unit is arranged for controlling the movement of the one or more cutting members to start the cut at one of the longitudinal edges and terminating the cut at the transition width short of the other of the longitudinal edges based on the detection of said other of the longitudinal edges by the one or more sensors.

In a further embodiment, the continuous strip is used as infeed material for an extruder, in which case the control unit can be arranged for receiving parameters from said extruder and for controlling the strip width in response to said parameters. By adjusting and/or variably adjusting the strip width, and consequently the width of the resulting continuous strip, the amount of material that is fed into the extruder can be controlled.

In another embodiment the one or more sensors are arranged for moving together with the one or more cutting members in the first cutting direction along the sheet to detect the first longitudinal edge and the second longitudinal edge in said first cutting direction. Hence, as the one or more cutting members approach one of the longitudinal edges, the one or more sensors can accurately detect the position thereof relative to the one or more cutting members.

In a further embodiment the one or more sensors comprises a first sensor located at a first side of the one or more cutting members in the first cutting direction for detecting the first longitudinal edge and a second sensor located at a second side of the one or more cutting members, opposite to the first side in the first cutting direction for detecting the second longitudinal edge. Consequently, each sensor can individually detect one of the longitudinal edges when moving in either direction of the bidirectional first cutting direction.

In a further embodiment the one or more drives comprises one or more first drive members for moving the one or more cutting members with respect to the feeding device in the first cutting direction. Hence, the one or more cutting members can be actively moved in said first cutting direction.

In a further embodiment the one or more drives comprises one or more second drive members for moving the one or more cutting members in a second cutting direction transverse to the feeding plane towards and away from the feeding plane. Hence, the one or more cutting members can be actively moved in the second cutting direction relative to the feeding plane. Hence, no means are required to lift the sheet up to the one or more cutting members.

In a further embodiment the control unit is arranged for moving the one or more cutting members in the second cutting direction between an active position in which the one or more cutting members intersect with the feeding plane and an inactive position in which the cutting member is spaced apart from the feeding plane. In the inactive position, the one or more cutting members do not cut the sheet. The one or more cutting members can for example be moved to the inactive position when said one or more cutting members are at the transition width short of one of the longitudinal edges. After moving to the inactive position, the one or more cutting members can be moved further in the first cutting direction into a starting position for the next cut in the sequence.

In an embodiment thereof the control unit is arranged for moving one of the one or more cutting members from the active position to the inactive position and back into the active position at least once during the creation of one of the cuts, wherein the control unit is further arranged for moving said one cutting member in the first cutting direction over a stroke distance when said one cutting member is in the inactive position to leave out at least one bridge intermitting said one cut. The stroke distance is chosen such that when said one cutting member cuts into the sheet again, it does so at a position that is sufficiently spaced apart from the previous cutting position so that the resulting cut is discontinuous or intermittent, i.e. has bridges. Bridges can be used to keep the sheet together despite the sequence of cuts, e.g. when storing the cut sheet prior to pulling it apart to form the continuous strip. The bridges serve as tear-off or break connections between the consecutive interconnected sheet sections.

In a further embodiment thereof the one cut is intermitted by at least two bridges, wherein the control unit is further arranged for moving said one cutting member in the first cutting direction over a cutting distance between said at least two bridges when the cutting member is in the active position, wherein the control unit is arranged for variably controlling the cutting distance. Hence, the spacing between bridges as a result of the cutting can be adjusted and/or variably adjusted depending on the requirements for the continuous strip.

Alternatively and/or additionally, the control unit is arranged for moving one of the one or more cutting member in the second cutting direction between the active position and the inactive position over an incision depth, wherein the control unit is arranged for variably controlling said incision depth. When the incision depth is relatively small, only a small portion of the cutting member cuts into the sheet. Hence, a relative small cut between two consecutive bridges can be obtained. In contrast, when the incision depth is relatively big, a considerable portion of the cutting member cuts into the sheet and a relative big cut between two consecutive bridges can be obtained.

In a further embodiment, which can be applied independently from the variably controlled strip width, the cutting device comprises two or more cutting members spaced apart in the feeding direction over the strip width to create two or more cuts of the sequence of cuts simultaneously. Hence, several cuts can be created at once. This can increase the efficiency of the cutting member. Moreover, simultaneous cutting actions may be convenient, in particular when the two or more cutting elements cut into the sheet from opposite sides, as with the inclined blades as discussed shortly hereafter. Hence, any lateral forces exerted onto the sheet during the cutting can be cancelled out.

In another embodiment the one more cutting members are one or more disc cutters. The one or more disc cutters can cut into the sheet at any position across its width. In combination with the control of the incision depth, it can be particularly advantageous that the circumference of the disc gradually increases with an increase in the incision depth.

In an alternative embodiment the one or more cutting members are one or more blades which are inclined with respect to the cutting line to progressively cut into the sheet. Preferably, the one or more blades comprise two guillotine blades with oppositely inclined cutting edges. The angle of the blade and/or the incision depth thereof controls the length of the cut and/or the direction of the cut. The oppositely inclined cutting edges can cancel out the lateral forces exerted on the sheet during the cutting to prevent bulging or displacement of the sheet.

In another embodiment the cutting device further comprises a cutting bar that is arranged on an opposite side of the feeding plane with respect to one of the one or more cutting members to define one of the one or more cutting lines, wherein the cutting bar is arranged for cutting the sheet in cooperation with said one cutting member along said one cutting line. The cutting bar can keep the sheet in the feeding plane while the cutting member cuts into the sheet. In the case of the disc cutter, said one cutting member can be positioned directly opposite to the cutting bar to cut against the opposite surface thereof. Alternatively, said one cutting member can cut along a side edge of the cutting bar. Said one cutting member can be moved in the second cutting direction towards the cutting bar. Alternatively, the one or more drives are arranged for moving the cutting bar towards and away from said one cutting member to provide the relative movement between said one cutting member and said one cutting line.

In another embodiment, which can be applied independently from the variably controlled strip width, the sheet is supplied to the apparatus from a stack, wherein the feeding device comprises a base that is fixed with respect to the cutting device, an input conveyor for pulling the sheet from the stack and an arm for supporting the input conveyor with respect to the base, wherein the arm is swivable with respect to said base for adjusting the height of the input conveyor relative to the stack. Optionally, the control unit is arranged for controlling the swiveling of the arm for following the stack with the input conveyor as the stack decreases during the feeding. Hence, the input conveyor can be positioned optimally, either manually or automatically, for taking the sheet in.

In a preferred embodiment thereof the input conveyor is swivable with respect to the arm to maintain an input orientation parallel or substantially parallel to the feeding plane. Again, the input conveyor can be positioned optimally for taking the sheet in.

In a further embodiment, that may also be applied independently of the variable strip width, the one or more sensors or one or more additional sensors are arranged for detecting sample holes in the sheet, wherein the sequence of cuts comprises a first group of cuts in a part of the sheet without a sample hole and a second group of cuts in a part of the sheet with a sample hole, wherein the control unit is arranged for controlling the movement of the one or more cutting members relative to the sheet in response to the detection of the sample hole such that the cuts of the second group on either side of the sample hole in the first cutting direction alternately extend in the first cutting direction from one of the longitudinal edges towards and terminate at a transition width short of the sample hole and extend in the first cutting direction from the sample hole towards and terminate at a transition width short of the respective longitudinal edge. The sample holes are created when taking sample material from the sheet, i.e. by punching, for compound analysis. The sample holes could potentially interrupt an otherwise continuous strip. By ensuring the that cuts terminate short of the sample hole, the continuity of the strip on either side of the sample hole can be ensured.

In a preferred embodiment thereof the control unit is arranged for variably controlling the strip width in response to the detection of a sample hole. Hence, the strip width can be adjusted to take into account the effect of the sample hole on the continuous strip.

In particular, the control unit is arranged for controlling the strip width resulting from the second group of cuts to be sixty percent or less of the strip width resulting from the first group of cuts. More preferably, the control unit is arranged for controlling the strip width resulting from the second group of cuts to be half of the strip width resulting from the first group of cuts. The sample hole causes the continuous strip to be locally split up into two branches, each branch having its own strip width. If the strip width remains unchanged, the amount of material that ultimately ends up in the continuous strip at the location of the two branches will be larger per unit length of the continuous strip compared to the continuous strip outside of said branches. By reducing the strip width, the amount of material in the continuous strip can be kept more uniform. Moreover, when the strip width is reduced by half, the combined branches can have the same or substantially the same strip width as the strip width in the rest of the continuous strip.

In another embodiment thereof the control unit is arranged for controlling the transition width resulting from the second group of cuts to be sixty percent or less of the transition width resulting from the first group of cuts. Preferably, the control unit is arranged for controlling the transition width resulting from the second group of cuts to be half of the transition width resulting from the first group of cuts. Similarly to the strip width, the transition width can be reduced to ensure the uniformity of the strip width of the continuous strip, in particular at said transitions.

According to a third aspect, the invention provides a method for converting a sheet into a continuous strip using the apparatus according to the first aspect or the second aspect of the present invention, wherein the method comprises detecting the cross section or the height profile of the strip.

The method according to the invention relates to the practical implementation of the aforementioned apparatus. Hence, the method and its embodiments have the same technical advantages as the apparatus and its corresponding embodiments, which will not be repeated hereafter.

In an embodiment thereof, the method further comprises calculating the volume of the strip and providing a signal to alert the operator.

In a further embodiment thereof, the method further comprises the steps of:
feeding the sheet in the feeding direction and in the feeding plane towards the one or more cutting members;
detecting the first longitudinal edge and the second longitudinal edge with the use of the one or more sensors;
providing a relative movement between the one or more cutting members and the sheet based on the detection of the first longitudinal edge and the second longitudinal edge by the one or more sensors to create the sequence of cuts; and
variably controlling the strip width.

In an embodiment of the method, for each cut of the sequence of cuts, the step of controlling the movement comprises the steps of:

starting the cut at one of the longitudinal edges, detecting the other of the longitudinal edges and terminating the cut at a transition width short of the other of the longitudinal edges based on the detection of said other of the longitudinal edges by the one or more sensors.

In one embodiment the transition width is kept constant. In an alternative embodiment the transition width is variably controlled.

Alternatively, the transition width is controlled to be equal or substantially equal to the strip width.

In a further embodiment, it is preferred that the continuous strip is used as infeed material for an extruder, wherein the strip width is controlled in response to parameters from the extruder.

In another embodiment, the method further comprises the step of detecting sample holes in the sheet, wherein the sequence of cuts comprises a first group of cuts in a part of the sheet without a sample hole and a second group of cuts in a part of the sheet with a sample hole, wherein the method further comprises the step of controlling the movement of the one or more cutting members relative to the sheet in response to the detection of the sample hole such that the cuts in the second group of cuts on either side of the sample hole in the first cutting direction alternately extend in the first cutting direction from one of the longitudinal edges towards and terminate at a transition width short of the sample hole and extend in the first cutting direction from the sample hole towards and terminate at a transition width short of the respective longitudinal edge.

In an embodiment thereof the method further comprises the step of variably controlling the strip width in response to the detection of a sample hole. Preferably, the method comprises the step of controlling the strip width resulting from the second group of cuts to be sixty percent or less of the strip width resulting from the first group of cuts. More preferably, the strip width resulting from the second group of cuts is controlled to be half of the strip width resulting from the first group of cuts.

In another embodiment thereof the transition width resulting from the second group of cuts is controlled to be sixty percent or less of the transition width resulting from the first group of cuts. Preferably, the transition width resulting from the second group of cuts is controlled to be half of the transition width resulting from the first group of cuts.

The various aspects and features described and shown in the specification can be applied, individually, wherever possible. These individual aspects, in particular the aspects and features described in the attached dependent claims, can be made subject of divisional patent applications.

### BRIEF DESCRIPTION OF THE DRAWINGS

The invention will be elucidated on the basis of an exemplary embodiment shown in the attached schematic drawings, in which:

FIGS. 1 and 2 show side view of the apparatus according to a first embodiment of the invention next to a sheet that is stacked onto a pallet to be fed into the apparatus via a feeding device, wherein the feeding device is shown in two positions depending on the height of the stack;

FIG. 3 shows a cross section of the apparatus according to line III-III in FIG. 1;

FIG. 4 shows a cross section of the apparatus according to line IV-IV in FIG. 1 and an exemplary sequence of cuts created by said apparatus in the sheet;

FIG. 5 schematically shows a cutting member of the apparatus and the path travelled by said cutting member during the cutting of the sheet;

FIG. 6 schematically shows an alternative path for the cutting member;

FIG. 7 shows an alternative sequence of cuts, comprising a plurality of cut sections intermitted by bridges, in the sheet;

FIG. 8 shows a further alternative sequence of cuts that takes into account sample holes in the sheet;

FIG. 9 shows an alternative apparatus according to a second embodiment of the invention; and

FIG. 10 show a further alternative apparatus according to a third embodiment of the invention.

### DETAILED DESCRIPTION OF THE INVENTION

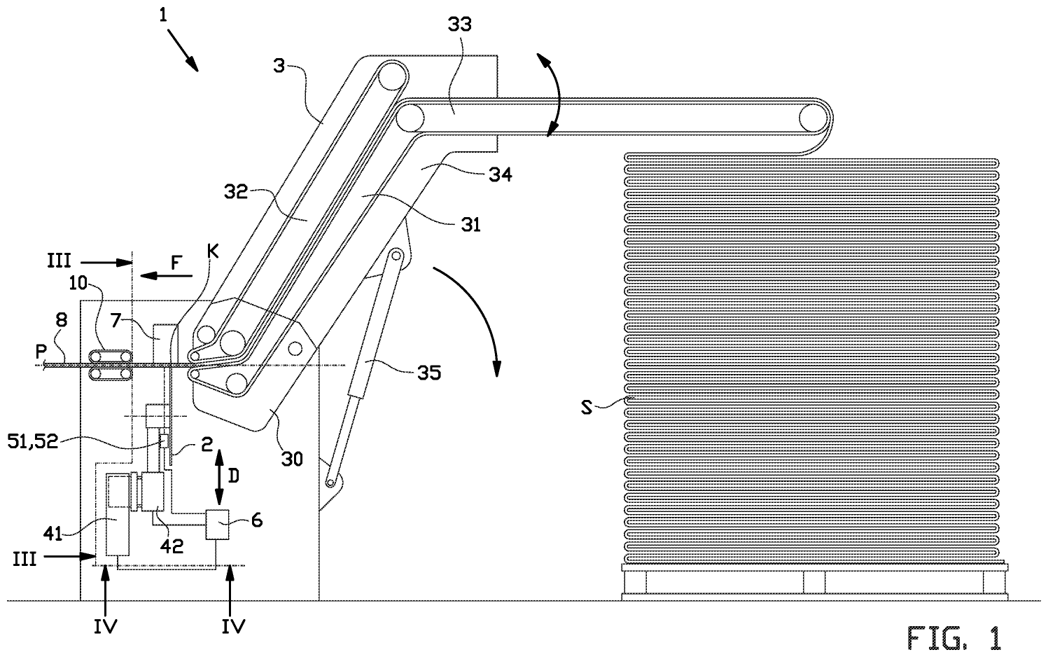

FIGS. 1-4 show an apparatus 1 for converting a sheet 8 of elastomeric material into a continuous strip 9 according to a first exemplary embodiment of the invention. Said continuous strip 9 can be used as infeed material for an extruder (not shown), in particular as part of a tire building process. For said tire building process, it is important that the sheet 8 can be reliably converted into a consistent continuous strip 9, i.e. a continuous strip 9 without interruption and/or with a consistent width, thickness, shape and/or volumetric rate.

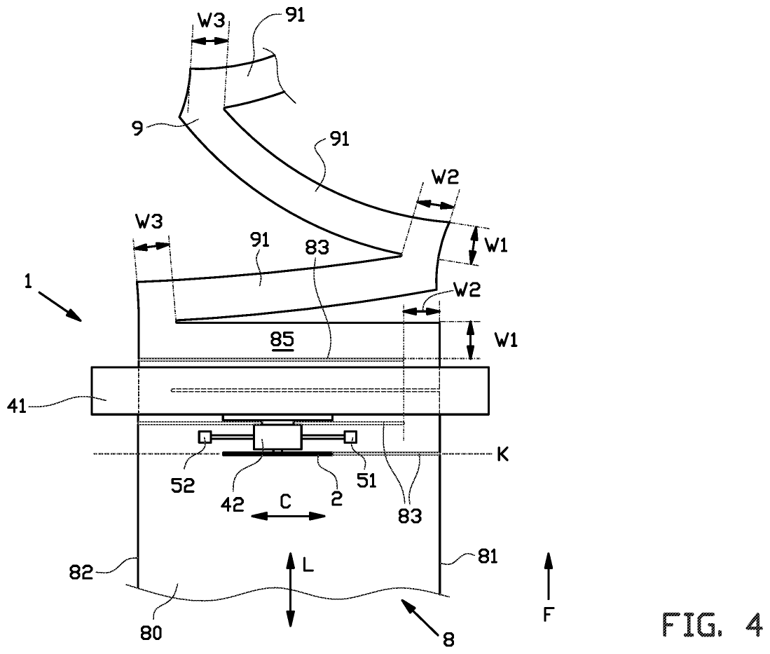

As shown in FIG. 1, the apparatus 1 comprises a cutting device with a cutting member 2 for cutting the sheet 8 and a feeding device 3 for feeding the sheet 8 in a feeding direction F and in a feeding plane P towards the cutting member 2. The sheet 8 is typically supplied to the apparatus 1 from a stack S. The sheet 8 is stacked in meandering layers on a pallet, ready to be pulled into the apparatus 1 layer by layer. The apparatus 1 further comprises an output device 10 for outputting and/or discharging the cut sheet 8 towards a downstream station, e.g. the extruder. When outputting directly to the extruder, the cut sheet 8 is arranged to be pulled apart into a continuous strip 9 with a plurality of interconnected zig-zag sections 91 as shown in FIG. 4 and in a manner known per se from WO 2017/171545 A1.

As shown in FIG. 1, the feeding device 3 comprises a base 30 that is in a fixed position with respect to the cutting member 2. The feeding device 3 is provided with a first transport conveyor 31 that is supported on said base 30 and that is arranged for supporting the sheet 8 from below during the feeding towards the cutting member 2. The feeding device 3 further comprises a second transport conveyor 32 that is supported on said base 30 in a position opposite to the first transport conveyor 31 for pressing the sheet 8 onto the first transport conveyor 31. By pressing the sheet 8, inconsistencies such as folds can be flattened prior to cutting. In this exemplary embodiment, the first transport conveyor 31 and the second transport conveyor 32 are belt conveyors with mutually facing, parallel transport runs. The transport runs can tightly clamp, press and transport the sheet 8.

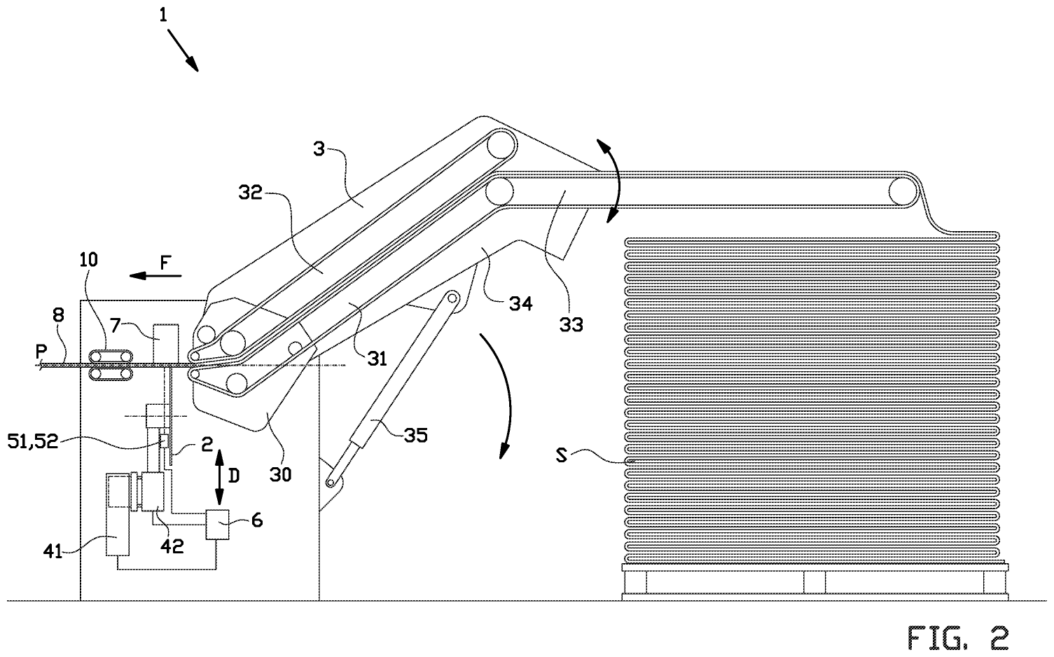

The feeding device 3 is further provided with an input conveyor 33 for pulling the sheet 8 from the stack S into the apparatus 1. The feeding device 3 comprises an arm 34 that supports the input conveyor 33 with respect to the base 30. Said arm 34 is swivable with respect to the base 30 to following the decreasing height of the stack (S). In this exemplary embodiment, the feeding device 3 is provided with a swivel actuator 35, e.g. a hydraulic or pneumatic piston, to actuate the swiveling. Preferably, the input conveyor 33 itself is also swivable with respect to the arm 34 to allow for the input conveyor 33 to follow or maintain parallel to the feeding plane P during the swiveling, as illustrated by comparing the position in FIG. 1 with the position in FIG. 2.

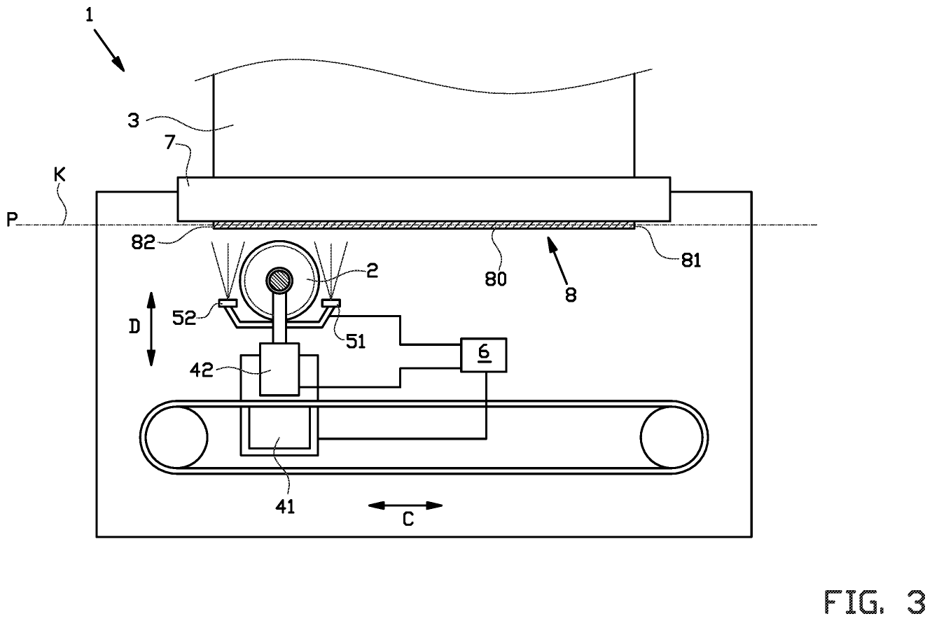

In this exemplary embodiment, the cutting member 2 is a disc cutter 2. The disc cutter 2 has a circular circumference or circular cutting edge, as best seen in FIG. 3, for cutting into the sheet 8. The disc cutter 2 is orientated in parallel with the first cutting direction C for cutting along a cutting line K parallel to said first cutting direction C. Alternatively a different cutting member 2 can be used, e.g. a non-circular cutting member like a ultrasonic knife. The apparatus 1 further comprises a counter member 7, in this example a cutting bar, that is arranged on an opposite side of the feeding plane P with respect to the cutting member 2 to define the cutting line K. The cutting bar 7 is arranged for cutting the sheet 8 in cooperation with the cutting member 2. The disc cutter 2 may cut against the surface of the cutting bar 7 directly opposite thereto. Alternatively, the disc cutter 2 can cut along a side edge of the cutting bar 7. In this exemplary embodiment, the disc cutter 2 is moved towards and away from the cutting bar 7 in a direction transverse to the feeding plane P. Alternatively, the cutting bar 7 may be moved towards the disc cutter 2. In other words, the cutting bar 7 may locally raise the cutting line K and/or the feeding plane P towards the disc cutter 2 to cut the sheet 8.

Optionally, the cutting device comprises one or more cutting elements, i.e. two disc cutters, spaced apart in the feeding direction F to create two cuts at once along two spaced apart cutting lines (not shown). The distance between the two disc cutters may be adjustable by an additional drive, not shown, operationally connected to the control unit 6 to vary the strip width W1.

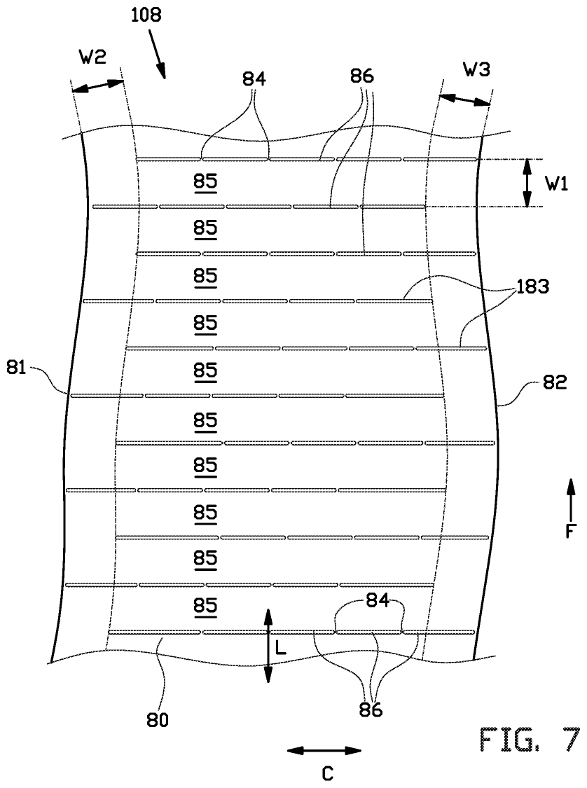

As shown in FIG. 7, the sheet 8 has a sheet body 80 extending in a longitudinal direction L and having a first longitudinal edge 81 and a second longitudinal edge 82 extending on opposite sides of the sheet body 80. The sheet body 80 is essentially a slab or raw material, in particular elastomeric or rubber material. The first longitudinal edge 81 and the second longitudinal edge 82 of said raw material are not necessarily consistent. As shown in an exaggerated manner in FIG. 7, while in general the longitudinal edges 81, 82 extend more or less in the longitudinal direction L, in some parts the longitudinal edges 81, 82 may converge towards each other, diverge away from each other or run off to either side with respect to the purely longitudinal direction L. As a result, the sheet 8 may shift, widen or narrow unexpectedly. The sheet 8 may have further inconsistencies in width, thickness and/or shape.

The apparatus 1 according to the invention is arranged for cutting said sheet 8 while taking into account said random inconsistencies. To this end, the apparatus 1, as shown in FIGS. 3 and 4, comprises one or more drives for controlling the relative movement between the cutting member 2 and the cutting line K and/or the sheet 8. In this example, the one or more drives comprises a first drive member 41 for moving the cutting member 2 with respect to the feeding device 3 in a first cutting direction C transverse to the feeding direction F and parallel to the feeding plane P. As best seen in FIG. 3, the one or more drives further comprises a second drive member 42 for providing a relative movement between the cutting member 2 and the cutting line K, in particular the cutting bar 7, in a second cutting direction D transverse to the feeding plane P towards and away from the feeding plane P. In particular, the second drive member 42 is arranged for moving the cutting member 2 between an active position in which the cutting member 2 intersects with the feeding plane P and an inactive position in which the cutting member 2 is spaced apart from the feeding plane P. Alternatively, the second drive member 42 may be arranged for moving the cutting bar 7 relative to the cutting member 2 to locally raise the cutting line K and/or the feeding plane P up to the position of the cutting member 2.

Moreover, the apparatus 1 is provided with one or more sensors 51, 52 for detecting the first longitudinal edge 81 and the second longitudinal edge 82 of the sheet 8. In this exemplary embodiment, the apparatus 1 is provided with a first sensor 51 located at a first side of the cutting member 2 in the first cutting direction C for detecting the first longitudinal edge 81 and a second sensor 52 located at a second side of the cutting member 2, opposite to the first side, in the first cutting direction C for detecting the second longitudinal edge 82. Preferably, the one or more sensors 51, 52 are arranged for moving together with the cutting member 2 in the first cutting direction C along the sheet 8 to detect the first longitudinal edge 81 and the second longitudinal edge 82 in said first cutting direction C during the movement of the cutting member 2. In this way, the positioning of the one or more sensors 51, 52 with respect to the cutting member 2 is known. Alternatively, the one or more sensors 51, 52 can be strategically located in fixed lateral positions to monitor side areas of the feeding plane P where they are most likely to detect the longitudinal edges 81, 82 of the sheet 8. In yet another alternative, a line camera, laser triangulation or another suitable detection means can be used to detect the height profile and/or cross section of the sheet 8 across the entire width thereof.

In this particular example, the one or more sensors 51, 52 are located just downstream of the cutting member 2 and face towards the cutting bar 7. The cutting bar 7 may be provided with a contrasting or reflective surface to easily detect the longitudinal edges 81, 82 against the backdrop of the cutting bar 7.

The apparatus 1 comprises a control unit 6 that is operationally and/or electronically connected to the first drive member 41, the second drive member 42 and the one or more sensors 51, 52. This allows for the movement of the cutting member 2 in the first cutting direction C and the second cutting direction D to be controlled relative to the sheet 8 based on the detection of the first longitudinal edge 81 and the second longitudinal edge 82 by the one or more sensors 51, 52. In particular, the one or more sensors 51, 52 are arranged for generating detection signals upon detection of the longitudinal edges 81, 82 and the control unit 6 is arranged for receiving said detection signals from the one or more sensors 51, 52. The control unit 6 stores and/or processes said detection signals and is arranged for sending control signals to the drive members 41, 42 to control the movement of the cutting member 2.

As shown in FIG. 4, the control unit 6 is further operationally and/or electronically connected to the feeding device 3 to control the feeding of the sheet 8 towards the cutting member 2. In particular, the control unit 6 is arranged to advance the sheet 8 after each cut 83 of the sequence of cuts 83 over a strip width W1 in the feeding direction F. Said strip width W1 determines the width of the continuous strip 9 at the zig-zag sections 91 after the sheet 8 has been pulled apart in the feeding direction F.

By accurately controlling the movements of the cutting member 2, the control unit 6 can cause the creation of a sequence of cuts 83 as shown in FIG. 4. The cuts 83 in said sequence of cuts 83 alternately extend in the first cutting direction C from one of the longitudinal edges 81, 82 towards and terminate at a transition width W2, W3 short of the other of the longitudinal edges 81, 82 to form a plurality of interconnected sheet sections 85. Said interconnected sheet sections 85 can then be pulled apart in the feeding direction F to form the zig-zag sections 91 of the continuous strip 9. The transition width W2, W3 determines the width of the transition from one of the zig-zag sections 91 to the next.

The detection of the longitudinal edges 81, 82 allows for the transition width W2, W3 at each longitudinal edge 81, 82 to be accurately controlled. In particular, when starting one of the cuts 83 at one of the longitudinal edges 81, 82, the one or more sensors 51, 52 are arranged for detecting the other of the longitudinal edges 81, 82 and for terminating said one cut 83 when the cutting member 2 is at a transition width W2, W3 short of the other of the longitudinal edges 81, 82. The termination of the cut 83 is obtained by retracting the cutting member 2 from the active position to the inactive position. The cutting member 2 can subsequently be moved beyond the respective longitudinal edge 81, 82 into a starting position for the next cut 83. The control unit 6 can be configured to keep the transition width W2, W3 constant. Alternatively, the transition width W2, W3 can be variably controlled and/or adjusted, e.g. depending on the requirements for the continuous strip 9 and/or in response to certain parameters of the downstream stations.

Furthermore, the control unit 6 can control the feeding device 3 to advance the sheet 8 between each cut 83 over an equal interval, thereby obtaining a constant strip width W1. Alternatively, the interval may be variably adjusted to variably control the strip width W1, e.g. depending on the requirements for the continuous strip and/or in response to certain parameters of the downstream stations. In particular, when the continuous strip 9 is used as infeed material for an extruder (not shown), the control unit 6 may be linked to said extruder to receive parameters from said extruder, e.g. related to the pressure in the extruder or the flow rate at the extruder. The control unit 6 can then be arranged to control the strip width W1 in response to one or more of said parameters. E.g. the strip width W1 may be decreased when the pressure in the extruder is too high to decrease the width of the continuous strip 9 and thus the flow of material to said extruder.

Preferably, the control unit 6 is arranged for controlling the transition width W2, W3 to be equal or substantially equal to the strip width W1. Hence, the consistency of the width of the continuous strip 9 can be increased. Moreover, when the strip width W1 is varied, the transition width W2, W3 can be varied accordingly.

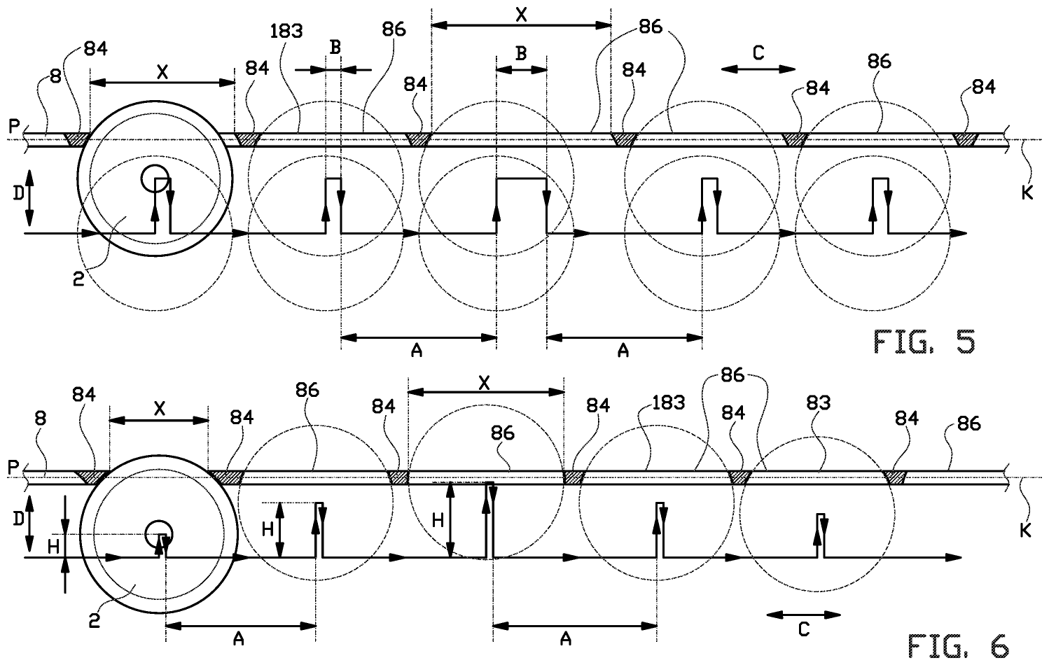

As shown in FIGS. 5 and 6, the movements of the cutting member 2 in the first cutting direction C and the second cutting direction D may optionally be controlled to create a sequence of alternative cuts 183 in which bridges 84 are left out, thereby intermitting said alternative cuts 183 and creating individual slits or cut sections 86 between the bridges 84. Said bridges 84 are arranged to hold the interconnected sheet sections 85, as shown in FIG. 7, together after cutting, e.g. when the cut sheet 8 is stored temporarily prior to processing in a downstream station. The bridges 84 serve as tear-off or break connections that can be broken relatively easily when pulling on the sheet sections 85 apart, along the cut sections 86, in the feeding direction F.

To create the bridges 84 in the alternative cuts 183, the control unit 6 is arranged for moving the cutting member 2 from the active position to the inactive position and back into the active position repeatedly during the creation of one of the alternative cuts 183 to form the cut sections 86. By additionally moving the cutting member 2 in the first cutting direction C over a stroke distance A when the cutting member 2 is in the inactive position, material is left out in the alternative cut 183 that forms one of the bridges 84. Said one bridge 84 effectively intermits said one alternative cut 183, dividing it into distinct and/or individual cut sections 86 with a certain slit length X. By variably controlling the stroke distance A, the width of the bridge 84 and thus its resistance to breaking can be controlled.

As shown in FIG. 5, the cutting member 2 can be moved between two bridges 84 over a cutting distance B in the first cutting direction C when the cutting member 2 is in the active position to cut the sheet 8. Hence, a new cut section 86 is created directly after each bridge 84 over a distance that is related to the cutting distance B. The control unit 6 is arranged for variably controlling the cutting distance B to variably control the length X of the cut sections 86 between two bridges 84.

Alternatively, as shown in FIG. 6, the control unit 6 may be arranged for moving the cutting member 2 in the second cutting direction D between the active position and the inactive position over an incision depth H that is variably controlled by the control unit 6. When the incision depth H is relatively small, only a small portion of the cutting member 2 cuts into the sheet 8. Hence, a relative short cut section 86 or slit length X between two consecutive bridges 84 can be obtained. In contrast, when the incision depth H is relatively big, a considerable portion of the cutting member 2 cuts into the sheet 8 and a relative long cut section 86 or slit length X between two consecutive bridges 84 can be obtained. In this alternative embodiment, the cutting member 2 does not need to be moved over a cutting distance B in the first cutting direction C. Instead, the cutting member 2 is merely moved up and down in the second cutting direction D and is only moved in the first cutting direction C in the inactive position.

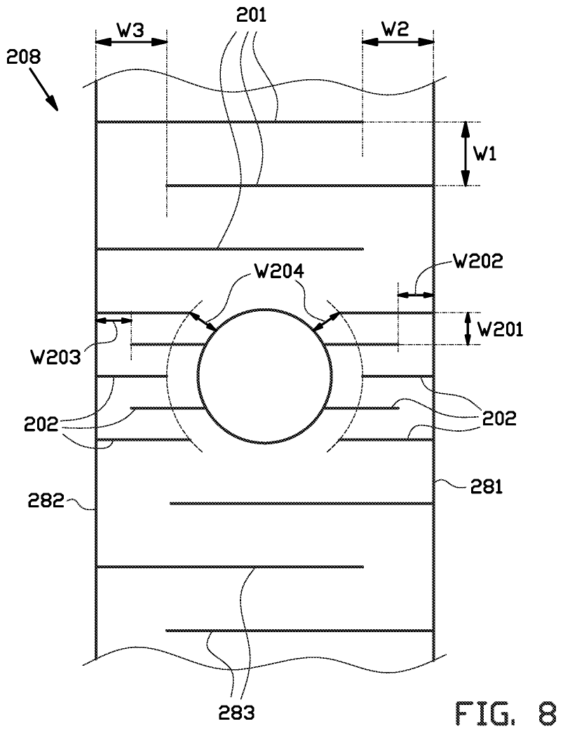

FIG. 8 shows an alternative sheet 208 with a further alternative sequence of cuts 283 that takes into account the presence or absence of sample holes 200 in the sheet 208. Said sample holes 200 are created when samples are taken from the sheet 208, i.e. by punching out small circular sections of the sheet 208, for compound analysis or other purposes. The sample holes 200 could potentially cause an interruption in the otherwise continuous strip 9. The one or more sensors 51, 52 or one or more additional sensors (not shown) are arranged for detecting the presence of such a sample hole 200 and adjust the pattern of the sequence of cuts 283 accordingly. This is a separate invention that can be applied independently from the strip width variation.

In particular, the sequence of cuts 283 comprises a first group 201 of cuts 283 in a part of the sheet 208 without any sample hole 200. Said first group 201 of cuts 283 are controlled relative to the longitudinal edges 81, 82 of the sheet 208 in the same manner as previously described to obtain or leave the strip width W1 and the transition widths W2, W3. The sequence of cuts 283 further comprises a second group 202 of cuts 283 in a part of the sheet 208 that comprises one or more sample holes 200. In particular, the cuts 283 of the second group 202 are located in the area at, around and/or in close proximity to one of the sample hole 200. The cuts 283 of the second group 202 are different from the cuts 283 in the first group 201 in that on either side of the sample hole 200 in the first cutting direction C they alternately extend in the first cutting direction C from one of the longitudinal edges 81, 82 towards and terminate at a transition width W204 short of the sample hole 200 and extend in the first cutting direction C from the sample hole 200 towards and terminate at a transition width W202, W203 short of the respective longitudinal edge 81, 82.

The cuts 283 of the second group 202 further leave or advanced over a strip width W201 that is smaller than the strip width W1 resulting from the cuts 283 of the first group 201. In addition, the transition widths W202, W203 resulting from the cuts 283 of the second group 202 at the respective longitudinal edges 281, 282 are also smaller than the transition widths W2, W3 resulting from the first group 201. Moreover, an additional transition width W204 is left at the boundary or circumference of the sample hole 200. Hence, it can be ensured that the strip remains continuous on either side of the sample hole 200.

Preferably, the strip width W201 and the transition widths W202, W203 resulting from the cuts 283 of the second group 202 are less than sixty percent of the strip width W1 and the transition widths W2, W3 resulting from the cuts 283 of the first group 201.

More preferably, the strip width W201 and the transition widths W202, W203 resulting from the cuts 283 of the second group 202 are half of the strip width W1 and the transition widths W2, W3 resulting from the cuts 283 of the first group 201. As a result, the combined strip widths W1 and the combined transition widths W2, W3 resulting from the cuts 283 of the second group 202 on either side of the sample hole 200 are cumulatively correspond to the strip width W1 and the transition widths W2, W3 resulting from the cuts 283 of the first group 201. Consequently, the amount of material that is fed into the extruder can be kept constant, even in the part of the strip that is affected by the sample hole 200. As a further optional feature of the apparatus 1 of the present invention the one or more sensors 51, 52 or one or more additional sensors may be arranged for detecting the cross section or the height profile of the sheet 8. This information can be used for variably controlling the strip width W1 in response to the detected cross section or the detected height profile. In particular, the control unit 6 can be arranged for calculating the volume of the sheet 8 that has passed the one or more sensors 51, 52 over a period of time, e.g. the volumetric rate of the sheet 8, from the cross section or the height profile. The control unit 6 can then send a notification signal to an operator when a predetermined value for the calculated volume has been reached. For example, when the volume or mass of the entire sheet 8 in the stack S, as shown in FIG. 1, is known, the control unit 6 may provide a timely signal to alert the operator to the fact that the stack S is nearly depleted.

FIG. 9 shows an alternative apparatus 301 according to a second exemplary embodiment of the invention. The alternative apparatus 301 differs from the previously discussed apparatus 1 in that it features an alternative cutting device 302 having one or more blades 321, 322 for cutting along one or more cutting lines K. The one or more blades 321, 322 are angled with respect to the one or more cutting line K to progressively cut into the sheet 8. In this exemplary embodiment, the one or more blades 321, 322 comprises a first guillotine blade 321 and a second guillotine blade 322 with oppositely angled, oblique cutting edges 323, 324. The guillotine blades 321, 322 are arranged to alternately cut into the sheet 8 from opposite longitudinal edges 81, 82 and to terminate short of the opposite longitudinal edge 81, 82, to obtain the interconnected sheet sections as previously described. The guillotine blades 321, 322 may be spaced apart in the feeding direction F to cut along respective cutting lines K which are spaced apart over the strip width W1. The spacing between the guillotine blades 321, 322 can be variable adjusted to adjust the strip width W1, i.e. by providing one or more drives (not shown), which are operationally connected to the control unit 6, to control the relative position of the guillotine blades 321, 322. Preferably, the guillotine blades 321, 322 are arranged to cut into the sheet 8 simultaneously so that the lateral forces exerted on the sheet 8 are cancelled out. After a cut by the guillotine blades 321, 322, the sheet 8 can be advanced by the feeding device 3 over one or more strip widths W1, depending on the number of cuts that are made simultaneously.

The length of each cut relative to the longitudinal side edges 81, 82 of the sheet 8 can be controlled by either controlling the movement of the blades 321, 322 in the first cutting direction C or by controlling the incision depth of the respective guillotine blade 321, 322 in the second cutting direction D in response to the detection signals of the one or more sensors.

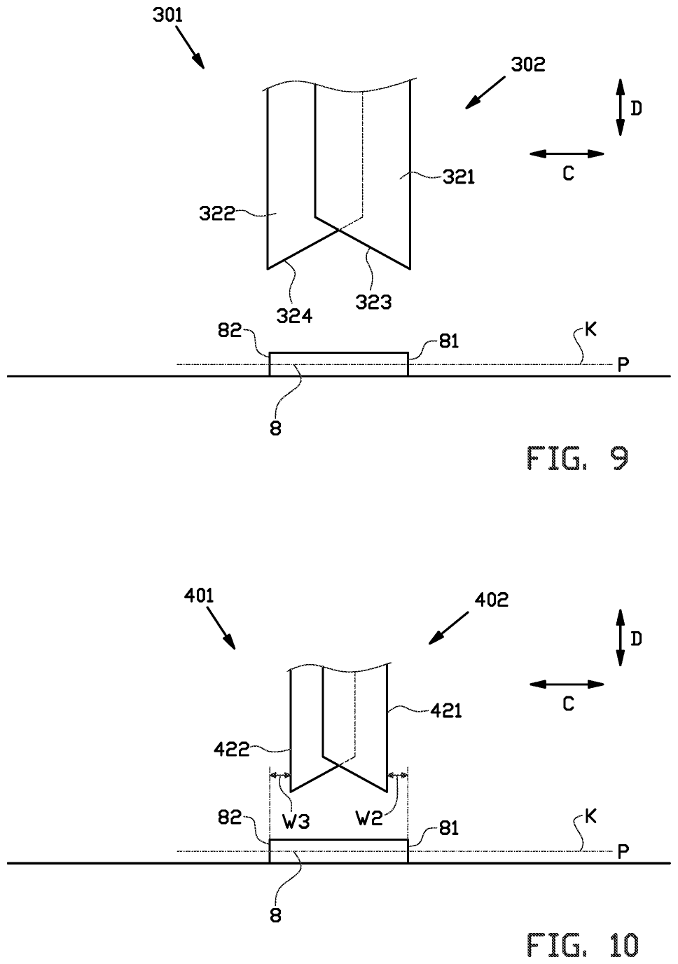

FIG. 10 shows a further alternative apparatus 401 according to a third exemplary embodiment of the invention. The further alternative apparatus 401 differs from the previously discussed alternative apparatus 301 in that the guillotine blades 421, 422 of its cutting device 402 are positioned to cut into the sheet 8 from the transition width W2, W3 towards the opposite longitudinal edge 81, 82, hence in the opposite direction compared to FIG. 9. Hence, the guillotine blades 421, 422 are movable in the first cutting direction C and the second cutting direction D to position the guillotine blades 421, 422 relative to the sheet 8. The guillotine blades 421, 422 may also be controlled in a similar way as the disc cutter 2 in FIGS. 5 and 6 to intermittently cut into the sheet 8 to create the bridges 84.

Optionally, in the embodiments as shown in FIGS. 9 and 10, the cutting member 302, 402 may be expanded with one or more additional blades (not shown) spaced apart in the feeding direction F over the strip width W1 for cutting additional cuts of the sequence of cuts simultaneously with the other blades of the same cutting device 302, 402 along additional, spaced apart cutting lines. Hence, several cuts can be created simultaneously, thereby allowing for a higher conveyance speed of the sheet 8 through the apparatus 301, 401.

It is to be understood that the above description is included to illustrate the operation of the preferred embodiments and is not meant to limit the scope of the invention. From the above discussion, many variations will be apparent to one skilled in the art that would yet be encompassed by the scope of the present invention.

### LIST OF REFERENCE NUMERALS

1 apparatus
2 cutting member
3 feeding device
30 base
31 first transport conveyor
32 second transport conveyor
33 input conveyor
34 arm
35 swivel actuator
41 first drive member
42 second drive member
51 first sensor
52 second sensor
6 control unit
7 cutting bar
8 sheet
80 sheet body
81 first longitudinal edge
82 second longitudinal edge
83 cut
84 bridge
85 sheet section
86 cut section
9 continuous strip
91 zig-zag section
10 output device
108 alternative sheet
183 alternative sequence of cuts
200 sample hole
201 first group of cuts
202 second group of cuts
208 further alternative sheet
283 further alternative sequence of cuts
301 alternative apparatus
302 cutting device
321 first blade
322 second blade
323 first oblique cutting edge
324 second oblique cutting edge
401 further alternative apparatus
402 cutting device
421 first blade
422 second blade
A stroke distance
B cutting distance
C first cutting direction
D second cutting direction
F feeding direction
H incision depth
K cutting line
L longitudinal direction
P feeding plane
X slit length
W1 strip width
W2 transition width
W3 transition width
W201 strip width
W202 transition width at first longitudinal edge
W203 transition width at second longitudinal edge
W204 transition width at sample hole

1. An apparatus for converting a sheet into a continuous strip, wherein the sheet has a sheet body extending in a longitudinal direction and having a first longitudinal edge and a second longitudinal edge extending on opposite sides of the sheet body, wherein the apparatus comprises a cutting device with one or more cutting members for cutting the sheet along one or more cutting lines and a feeding device for feeding the sheet in a feeding direction and in a feeding plane across the one or more cutting lines, wherein the apparatus comprises one or more drives for providing a relative movement between the one or more cutting members and the sheet, wherein the apparatus is provided with one or more sensors for detecting the first longitudinal edge and the second longitudinal edge and a control unit that is operationally connected to the one or more drives, the feeding device and the one or more sensors for controlling the movement of the one or more cutting members relative to the sheet based on the detection of the first longitudinal edge and the second longitudinal edge by the one or more sensors to create a sequence of cuts in which the cuts are spaced apart in the feeding direction over a strip width and alternately extend in a first cutting direction transverse to the feeding direction and parallel to the feeding plane from one of the longitudinal edges towards and terminate at a transition width short of the other of the longitudinal edges to form a plurality of interconnected sheet sections, wherein the one or more sensors or one or more additional sensors are arranged for detecting the cross section or the height profile of the sheet, and wherein the control unit is arranged for variably controlling the strip width in response to the detected cross section or the detected height profile.

2. The apparatus according to claim 1, wherein the control unit is further arranged for variably controlling the transition width in response to the detected cross section or the detected height profile.

3. The apparatus according to claim 1, wherein the control unit is arranged for keeping the transition width constant.

4. The apparatus according to claim 1, wherein the transition width is controlled to be equal to the strip width.

5. The apparatus for converting a sheet into a continuous strip, wherein the sheet has a sheet body extending in a longitudinal direction and having a first longitudinal edge and a second longitudinal edge extending on opposite sides of the sheet body, wherein the apparatus comprises a cutting device with one or more cutting members for cutting the sheet along one or more cutting lines and a feeding device for feeding the sheet in a feeding direction and in a feeding plane across the one or more cutting lines, wherein the apparatus comprises one or more drives for providing a relative movement between the one or more cutting members and the sheet, wherein the apparatus is provided with one or more sensors for detecting the first longitudinal edge and the second longitudinal edge and a control unit that is operationally connected to the one or more drives, the feeding device and the one or more sensors for controlling the movement of the one or more cutting members relative to the sheet based on the detection of the first longitudinal edge and the second longitudinal edge by the one or more sensors to create a sequence of cuts in which the cuts are spaced apart in the feeding direction over a strip width and alternately extend in a first cutting direction transverse to the feeding direction and parallel to the feeding plane from one of the longitudinal edges towards and terminate at a transition width short of the other of the longitudinal edges to form a plurality of interconnected sheet sections, wherein the one or more sensors or one or more additional sensors are arranged for detecting the cross section or the height profile of the sheet, wherein the control unit is arranged for variably controlling the transition width in response to the detected cross section or the detected height profile.

6. The apparatus according to claim 5, wherein the control unit is arranged for variably controlling the strip width.

7. The apparatus according to claim 1, wherein the apparatus comprises a line camera for detecting the cross section or the height profile of the sheet.

8. The apparatus according to claim 1, wherein the apparatus comprises laser triangulation for detecting the cross section or the height profile of the sheet.

9. The apparatus according to claim 1, wherein the control unit is arranged for calculating the volume or the mass of the sheet that has passed the one or more sensors or the one or more additional sensors from the cross section or the height profile.

10. The apparatus according to claim 9, wherein the control unit is arranged for sending a notification signal to an operator when a predetermined value for the volume or the mass has been reached.

11. The apparatus according to claim 10, wherein the sheet is supplied to the apparatus from a stack, wherein the predetermined value is related to the volume or mass of the entire sheet in the stack, and wherein the control unit is arranged to provide the notification signal to alert the operator that the stack is nearly depleted.

12. The apparatus according to claim 1, wherein, for each cut of the sequence of cuts, the control unit is arranged for controlling the movement of the one or more cutting members to start the cut at one of the longitudinal edges and terminating the cut at the transition width short of the other of the longitudinal edges based on the detection of said other of the longitudinal edges by the one or more sensors.

13. The apparatus according to claim 1, wherein the one or more sensors are arranged for moving together with the one or more cutting members in the first cutting direction along the sheet to detect the first longitudinal edge and the second longitudinal edge in said first cutting direction.

14. The apparatus according to claim 1, wherein the one or more sensors comprises a first sensor located at a first side of the one or more cutting members in the first cutting direction for detecting the first longitudinal edge and a second sensor located at a second side of the one or more cutting members, opposite to the first side in the first cutting direction for detecting the second longitudinal edge.

15. The apparatus according to claim 1, wherein the one or more drives comprises one or more first drive members for moving the one or more cutting members with respect to the feeding device in the first cutting direction.

16. The apparatus according to claim 1, wherein the one or more drives comprises one or more second drive members for moving the one or more cutting members in a second cutting direction transverse to the feeding plane towards and away from the feeding plane.

17. The apparatus according to claim 5, wherein the apparatus comprises a line camera for detecting the cross section or the height profile of the sheet.

18. The apparatus according to claim 5, wherein the apparatus comprises laser triangulation for detecting the cross section or the height profile of the sheet.

19. The apparatus according to claim 5, wherein the control unit is arranged for calculating the volume or the mass of the sheet that has passed the one or more sensors or the one or more additional sensors from the cross section or the height profile.

20. The apparatus according to claim 19, wherein the control unit is arranged for sending a notification signal to an operator when a predetermined value for the volume or the mass has been reached.

21. The apparatus according to claim 20, wherein the sheet is supplied to the apparatus from a stack, wherein the predetermined value is related to the volume or mass of the entire sheet in the stack, and wherein the control unit is arranged to provide the notification signal to alert the operator that the stack is nearly depleted.

22. The apparatus according to claim 5, wherein, for each cut of the sequence of cuts, the control unit is arranged for controlling the movement of the one or more cutting members to start the cut at one of the longitudinal edges and terminating the cut at the transition width short of the other of the longitudinal edges based on the detection of said other of the longitudinal edges by the one or more sensors.

23. The apparatus according to claim 5, wherein the one or more sensors are arranged for moving together with the one or more cutting members in the first cutting direction along the sheet to detect the first longitudinal edge and the second longitudinal edge in said first cutting direction.

24. The apparatus according to claim 5, wherein the one or more sensors comprises a first sensor located at a first side of the one or more cutting members in the first cutting direction for detecting the first longitudinal edge and a second sensor located at a second side of the one or more cutting members, opposite to the first side in the first cutting direction for detecting the second longitudinal edge.

25. The apparatus according to claim 5, wherein the one or more drives comprises one or more first drive members for moving the one or more cutting members with respect to the feeding device in the first cutting direction.

26. The apparatus according to claim 5, wherein the one or more drives comprises one or more second drive members for moving the one or more cutting members in a second cutting direction transverse to the feeding plane towards and away from the feeding plane.

27. A method for converting a sheet into a continuous strip using the apparatus according to claim 1, wherein the method comprises detecting the cross section or the height profile of the strip.

28. The method according to claim 27, wherein the method further comprises calculating the volume of the strip and providing a signal to alert the operator.

29. The method according to claim 27, wherein the method further comprises the steps of:
feeding the sheet in the feeding direction and in the feeding plane towards the one or more cutting members;
detecting the first longitudinal edge and the second longitudinal edge with the use of the one or more sensors;
providing a relative movement between the one or more cutting members and the sheet based on the detection of the first longitudinal edge and the second longitudinal edge by the one or more sensors to create the sequence of cuts; and
variably controlling the strip width or the transition width in response to the detected cross section or the detected height profile.

30. The method according to claim 29, wherein for each cut of the sequence of cuts, the step of controlling the movement comprises the steps of:
starting the cut at one of the longitudinal edges, detecting the other of the longitudinal edges and terminating the cut at a transition width short of the other of the longitudinal edges based on the detection of said other of the longitudinal edges by the one or more sensors.

31. A method for converting a sheet into a continuous strip using the apparatus according to claim 5, wherein the method comprises detecting the cross section or the height profile of the strip.

32. The method according to claim 31, wherein the method further comprises calculating the volume of the strip and providing a signal to alert the operator.

33. The method according to claim 31, wherein the method further comprises the steps of:
feeding the sheet in the feeding direction and in the feeding plane towards the one or more cutting members;
detecting the first longitudinal edge and the second longitudinal edge with the use of the one or more sensors;
providing a relative movement between the one or more cutting members and the sheet based on the detection of the first longitudinal edge and the second longitudinal edge by the one or more sensors to create the sequence of cuts; and
variably controlling the strip width or the transition width in response to the detected cross section or the detected height profile.

34. The method according to claim 33, wherein for each cut of the sequence of cuts, the step of controlling the movement comprises the steps of:
starting the cut at one of the longitudinal edges, detecting the other of the longitudinal edges and terminating the cut at a transition width short of the other of the longitudinal edges based on the detection of said other of the longitudinal edges by the one or more sensors.
